(19) United States
(12) Patent Application Publication
(10) Pub. No.: US 2002/0017056 A1
(43) Pub. Date: Feb. 14, 2002

(54) Wheeled self-watering tray

(76) Inventor: Jianhua Fan, Nashville, TN (US)

Correspondence Address: JIANHUA FAN, 5800 MAUDINA AVE. # C-2, NASHVILLE, TN, 37209, US

(21) Appl. No.: 09/948,433

(22) Filed: Sep. 7, 2001

Related U.S. Application Data
(63) Continuation-in-part of application No. 09/605,606, filed on Jun. 28, 2000.
(60) Provisional application No. 60/185,111, filed on Jul. 12, 2000.

(51) Int. Cl. A01G 9/02

(52) U.S. Cl. 47/66.6

(57) ABSTRACT

A wheeled self-watering tray for a pot having bottom hole(s) includes a tray, a plurality of wheels, and a fluid sucking material. Each of the wheels has a connecting part to connect to the tray. The tray includes a side wall, a bottom wall, and a plurality of raised portions raised from a bottom wall or a side wall or both the bottom and side walls of the tray. The pot sits on the raised portions of the tray, and the accompanied fluid sucking material being inserted into a bottom hole of the pot and sucking fluid from the tray to the pot when it is in use.

### RELATED PATENT APPLICATION

This patent application is a continuation-in-part patent application of U.S. patent application Ser. No. 09/605,606, filed Jun. 28, 2000; which claims the benefit of Provisional Application, U.S. Serial No. 60/185,111, filed on Feb. 25, 2000, entitled “WHEELED POT”, by Jianhua Fan; subject matter of which are bereby incorporated by reference.

### BACKGROUND OF THE INVENTION

1. Field of the Invention

The present invention relates to a self-watering tray, more particularly to a wheeled self-watering tray apparatus.

2. Description of the Prior Art

Most of the existing tray for a plant pot have no wheel. It is often difficult to move a pot apparatus with no wheel, particularly a large or heavy pot apparatus with a plant or flower planted therein, for the purposes of such as cleaning the floor or moving the pot apparatus to sunlight.

Some existing tray have wheel, but does not self-watering apparatus. If the excessive water were not removed periodically, the roots of a plant would be damaged.

It can be seen then that there is a need for a wheeled self-watering tray capable of holding a conventional pot.

It is with respect to these and other considerations that the present invention has been made.

### SUMMARY OF THE INVENTION

The present invention relates to a self-watering tray, more particularly to a wheeled self-watering tray apparatus.

The present invention discloses a wheeled self-watering tray apparatus. The wheeled self-watering tray is capable of holding a conventional pot, being moved easily, and avoid roots damage caused by excessive water.

In one embodiment of the present invention, a tray apparatus includes: a tray, the tray having a side wall and a bottom wall, a plurality of raised portions raised from the bottom wall; a plurality of wheels, each of the wheels having a connecting part to connect to the tray, and a fluid sucking material or the fluid sucking material inserted into a tube, one end inserted into a bottom hole of a pot, other end being disposed in a fluid source in the tray.

Further in one embodiment, the tray includes a plurality of raised portion raised from the bottom wall, each of the raised portion has a side wall, a top wall, and a receiving bore, the receiving bore engageably receives the connecting part of the wheel.

Still in one embodiment, at least one of the raised portion of the tray has an upper section and a lower section, the upper section is inserted into a bottom hole of a pot, the pot sits on the shoulder between the upper and the lower section, one end of a fluid sucking material may be attached on the upper section, the other end being disposed in a fluid source in the tray.

In one embodiment, the tray includes a plurality of raised portions raised from both the side wall and the bottom wall, each of the raised portions has a side wall, a top wall, and a plurality of wheels, each of the wheels having a connecting part to connect to the tray, the connect mean the connecting part of the wheels being scrow on/glue on to the bottom of the tray or other way to connect to the tray.

Still in one embodinebt, the tray apparatus includes a connector disposed on the lower surface of the bottom wall of the tray, the connector engageably receives the connecting part of the wheel.

Additionally in one embodiment, the tray includes a plurality of raised portion raised from both the side wall and the bottom wall, each of the raised portion has a side wall, a top wall, and a receiving bore. The receiving bore engageably receives the connectong part of the wheel.

More still in one embodiment, the tray includes a plurality of raised portion raised from the side wall of the tray, each of the raised portion has a side wall, a top wall, and may has a receiving bore.

Yet in one embodiment, the tray includes a watering lip.

These and various othere advantages and features of novelty which characterize the invention are pointed out with particularity in the claims annexed hereto and form a part hereof However, for a better understanding of the invention, its advantages, and the objects obtained by its use, reference should be made to the drawings which form a further part hereof, and to accompanying descriptive matter, in which there are illustrated and described specific examples of an apparatus in accordance with the invention.

### BRIEF DESCRIPTION OF THE DRAWINGS

Referring now to the drawings in which like reference numbers represent corresponding parts throughout:

FIG. 19 is a partial perspective view of a first embodiment of a connector coupled to a wheeled tray apparatus in accordance with the principles of the present invention.

FIG. 20 is a partial perspective view of a second embodiment of a connector coupled to a wheeled tray apparatus in accordance with the principles of the present invention.

FIG. 21 is a perspective view of a third embodiment of a connector coupled to a wheeled tray apparatus in accordance with the principles of the present invention.

FIGS. 22A, 22B, 22C are perspective views of a variety of connectors in accordance with the principles of the present invention.

FIG. 23 is a perspective view of a generally illustration of a wheeled tray with a part of the tray cut open for illustration.

FIG. 24 is a perspective view of a wheel being inserted into a receiving bore of a conncetor.

FIG. 28 is a perspective view of fourth embodiment of a wheeled tray with a part of the tray cut open for illustration.

FIG. 29 is a perspective view of a fifth embodiment of a wheeled tray in accordance with the principles of the present invention.

FIG. 30 is a perspective view of a sixth embodiment of a wheeled tray in accordance with the principles of the present invention.

### DETAILED DESCRIPTION OF THE PREFERRED EMBODIMENT

In the following description of the exemplary embodiment, reference is made to the accompanying drawings which form a part hereof, and in which it is shown by way of illustration the specific embodiment in which the invention may be practiced. It is to be understood that other embodiments may be utilized as structural changes may be made without departing from the scope of the present invention.

The present invention provides a wheeled self-watering tray apparatus. The wheeled self-watering tray apparatus is accordance with the principles of the present invention is capable of holding a conventional pot, being moved easly and is capable of self-watering to avoid root damages cased by excessive water.

In FIG. 23, there is generally illustrated by reference numeral 2 one embodiment of a wheeled self-watering tray apparatus in accordance with the principles of the present invention. The wheeled self-watering tray apparatus 2 includes a tray 4, a plurality of wheels 8, and a fluid sucking material (not shown) inserted into a bottom hole of a conventional pot (not shown) for sucking fluid from the tray to the pot for plant use. The tray 4 has a side wall 5 and a bottom wall 3, and a plurality of raised portion 14 raised from the bottom wall, the conventional pot sits on the raised portions. The pot and the tray 4 are supported and movable by the wheels 8.

In FIG. 23, the raised portions 14 may have side wall and top wall, at least one of the raised portions 14 may also include a upper section 55 and lower section 57, the upper portion raised from the top wall of the raised portion 14. The pot sits on a shoulder 59 between the upper section 55 and the lower section 57 and the top surfaces of the other raised portions 14. The raised portion 14 may also having a receiving bore 20 to receives the connecting part 9 of the wheel 8.

In FIG. 23, the tray 4 may also include a mouth/lip section 68 for adding fluid into the tray.

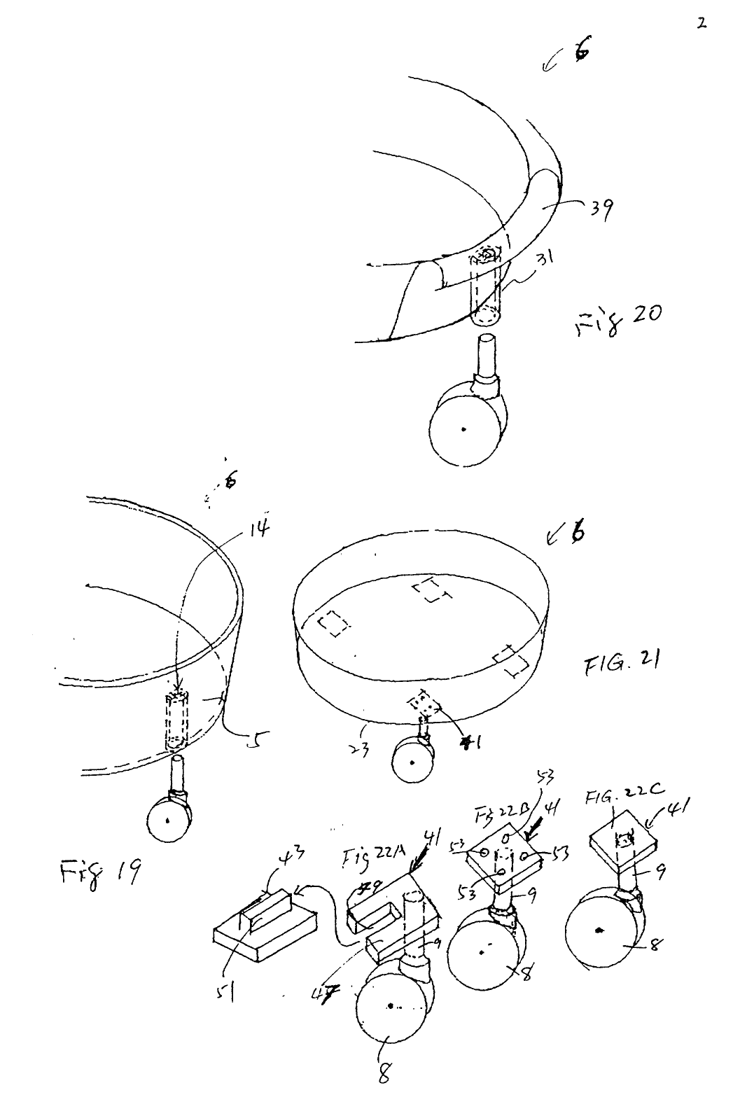

FIG. 19 illustrate first embodiment of the raised portions 14 in the wheeled tray 6. In FIG. 19, the raised portion 14 is coupled to the inside of the side wall 5 of the tray 6. The wheeled tray 6 can be used in conjunction with a conventional pot (not shown) that may not have a tray. The wheeled tray 6 includes a raised portion 14 raised from the bottom wall 3. The raised portion 14 is support the bottom of a pot (not shown), or say a pot sits on the raised portions. The tray 6 can be a self-watering when a fluid sucking material inserted into a bottom hole of the pot. A pot sits on the raised portions with more stable when the upper section 33 of raised portion 14 inserted into a bottom hole of a pot.

FIG. 20 illustrates a second embodiment of the connector 31 being coupled to the outside of the side wall 5 of the tray 6. the elements shown in the second embodiment are similar to the elements shown in the first embodiment of FIG. 19, except that in FIG. 20, the tray 6 has a curved edge 39 at the top of the side wall 5. The raised portions 14 for supporting a pot does not shown in the FIG. 20.

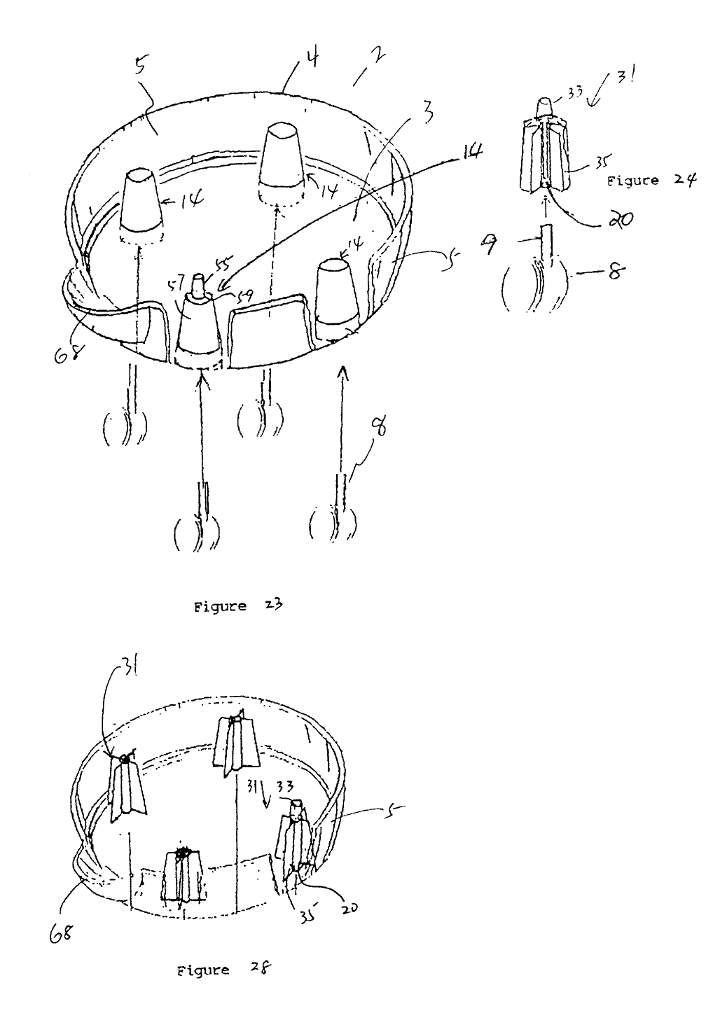

FIG. 21 illustrates a third embodiment of the connector 31 being coupled to the bottom wall 23 of the tray 6. The connecting part 9 also includes a mounting section 41. the mounting section 41 is screwed onto the bottom wall 23 of the tray 6. FIGS. 22A, 22B, 22C illustrate other various types of mounting sections 41 in accordance with the principles of the present invention. The raised portions 14 does not shown in the FIG. 21.

In FIG. 22A, the mounting section 41 includes a male member 43 and a female member 47. The member 43 can be integral with the bottom wall 23 of the tray 6, and the female member 47 is coupled to the member 43 by sliding a groove 49 of the female member 47 over a projecting member 51 of the male member 43. The female member 47 and male member 43 can be secured by screw means or other functionally similar means.

In FIG. 22B, the connecting part 9 includes the mounting section 41. The mounting section 41 is mounted onto the bottom wall 23 of the tray 6 via holes 53 by screw means or other functionally similar means.

In FIG. 22C, the connecting part 9 also includes the mounting section 41. The mounting section 41 is directly glued onto the bottom wall 23 of the tray 6.

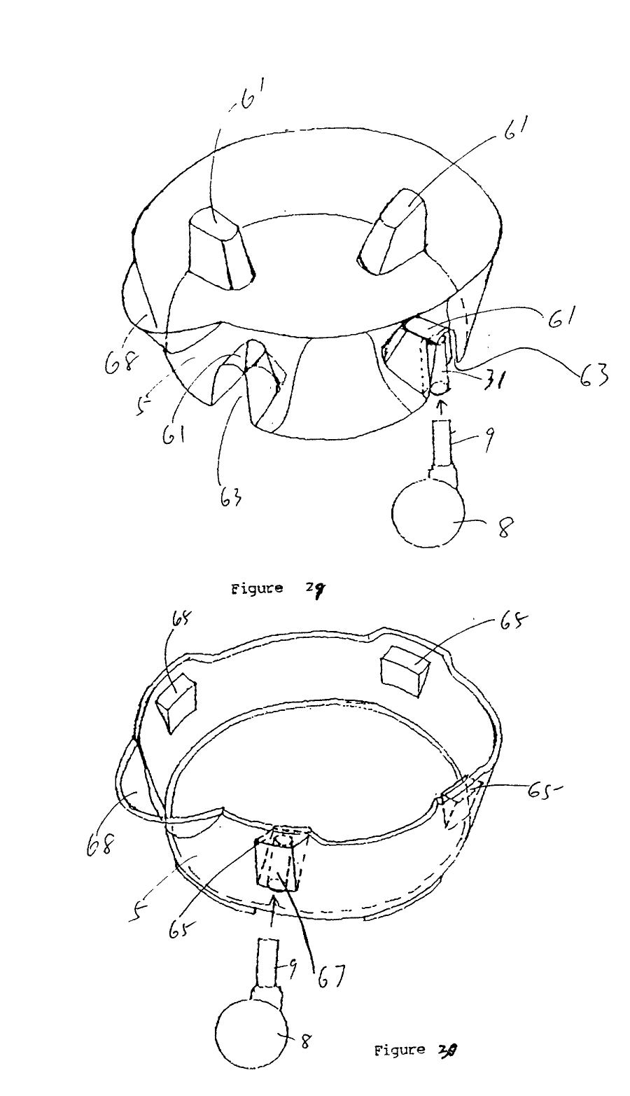

In FIG. 24, the connectors can be placed in the raised portion 14 as shown in FIG. 23. The connector can be the same as the connector 31 as discussed above.

FIG. 28 illustrates a fourth embodiment of the wheeled tray 6. The lower section of the connectors 31 is different with the connector 31 of FIG. 23 and integrally disposed in the tray 6. The receiving bore 20 of each of the connectors 31 is aligned to the wheel 8 underneath the tray 6 such that the connecting part 9 of the wheels 8 can be inserted into the receiving bores 20 of the connectors 31.

FIG. 29 illustrates a fifth embodiment of the wheeled tray 6. the tray 6 includes a plurality of raised portions 61 projected from both the side wall 5 and the bottom wall 3 of the tray 6. The raised portions 61 are provided to support the pot . Further, the raised portions 61 form a plurality of hollow sections 63 between the side wall 5 and the bottom wall 3. A plurality of connector 31 (only one is shown in FIG. 29) are disposed within the hollow sections 63 to couple to connecting parts 9 of the wheels 8.

FIG. 30 illustrates a sixth embodiment of the wheeled tray 6. the tray 6 includes a plurality of raised portions 65 projected from the side wall 5 of the tray 6. The raised portions 65 are provided to support the pot. Further, the raised portions 65 may include a receiving bore 67 to couple to the connecting part 9 of the wheel 8.

In FIGS. 23, 28, 29 and 30, the mounth/lip section 68 is disposed on the side wall 5 of the tray 6. It is appreciated that the mouth section 68 can be disposed at various places on the tray 6.

The foregoing description of the exemplary embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather by the claims appended hereto.

1. A wheeled self-watering tray for a pot having bottom hole(s), comprising:
a tray, the tray having a side wall and a bottom wall, and a plurality of raised portions raised from the wall of the tray, a pot sits on the raised portions; and
a plurality of wheels, each of the wheels having a connecting part to connect to the tray; and
a fluid sucking material, a first end of the fluid sucking material being inserted into the bottom hole of the pot, and a second end of the fluid sucking material being disposed in a fluid source in the tray.

2. The tray apparatus of claim 1, further comprising a tube, the tube filled with the fluid sucking material, a first end of the tube being inserted into the bottom hole of the pot, and the second end of the tube being disposed in a fluid source in the tray.

3. The tray apparatus of claim 1, wherein the raised portion of the tray has a side wall, a top wall, and a receiving bore, the receiving bore engageably receives the connecting part of the wheel.

4. The tray apparatus of claim 1, wherein at least one of the raised portions of the tray has an upper section and a lower section, the upper section is inserted into the corresponding bottom hole of the pot, and the pot sits on a shoulder between the upper section and the lower section and the top surfaces of the other raised portions.

5. The tray apparatus of claim 1, further comprising a connector disposed on the lower bottom surface of the tray, the connector engageably receives the connecting part of the wheel.

6. The tray apparatus of claim 1, wherein the tray includes a watering lip.

7. The tray apparatus of claim 1, wherein the connect is means.

8. The tray apparatus of claim 7, wherein the connect mean the wheel has a connecting part and its screwed onto the tray.

9. The tray apparatus of claim 7, wherein the connect mean the wheel has a connecting part and its glued onto the tray.
